(19) United States
(12) Patent Application Publication
(10) Pub. No.: US 2011/0127945 A1
(43) Pub. Date: Jun. 2, 2011

(54) FORCED DISCHARGE MECHANISM AND SAFETY SWITCH DEVICE FOR STORAGE BATTERY

(76) Inventor: Tetsuya YONEDA, Osaka (JP)

(21) Appl. No.: 12/956,150

(22) Filed: Nov. 30, 2010

(30) Foreign Application Priority Data
Nov. 30, 2009 (JP) 2009-272252

(51) Int. Cl. H01M 10/46; H02J 7/00

(52) U.S. Cl. 320/101; 320/135; 320/136; 180/65.29

(57) ABSTRACT

A forced discharge mechanism for a storage battery for forcibly establishing conduction between a pair of power transport paths that are respectively connected to a positive electrode terminal and a negative electrode terminal of the storage battery includes an electric resistor for establishing conduction between the power transport paths, and the electric resistor is movable due to a buoyant force of liquid that has entered.

### BACKGROUND OF THE INVENTION

This application claims priority under 35 U.S.C. §119(a) on Patent Application No. 2009-272252 filed in Japan on Nov. 30, 2009, the entire contents of which are herein incorporated by reference.

The present invention relates to a forced discharge mechanism for a storage battery and a safety switch device, such as, for example, a forced discharge mechanism for a storage battery and a safety switch device that are provided in a battery module having a protective function.

Examples of a conventional storage battery (secondary battery) include a battery module having a protective function that operates when an abnormal condition occurs.

As an example of such a battery module having a protective function, a battery module having a protective function that operates when an abnormal condition such as getting wet occurs is described below.

For example, storage batteries in battery modules that are used outdoors have become rapidly widespread in recent years for the purpose of backing up electric power generated by a power generation system such as a solar power generation system, and as a power source for vehicles typified by hybrid electric vehicles (HEVs), plug-in electric vehicles (PinEVs), plug-in hybrid electric vehicles (PHVs or PHEVs), and electric vehicles (PEVs).

Such storage batteries tend to be increasing in size (increasing in capacity) in order to be used over several years while being repeatedly charged and discharged, or in order to improve the utilization cycle from a single charge as in the case of being utilized in vehicles such as electric vehicles. If liquid such as water or sea water enters into such storage batteries when an abnormal condition such as getting wet occurs, an electric leakage or a short circuit occurs between positive and negative electrode terminals of the storage batteries, which may cause a problem such as generation of heat.

Specifically, with regard to the environment where storage batteries are used, there are concerns about the influence on storage batteries of getting wet or the like, due to cars becoming submerged or being washed away as a result of roads becoming covered in water or flooded caused by the overflowing of rivers, or to houses becoming immersed in water, for instance, because of the recent abnormal weather or the like.

For this reason, it is desired to provide storage batteries with a protective function that operates when an abnormal condition occurs.

An example of such a protective function is a safety switch device that disables charging and discharging of the storage battery by interrupting a power transport path connected between an external power source and the storage battery.

For example, JP 2002-42752A (Patent Document 1) discloses a battery pack that blows a thermal fuse connected in series to a power transport path between an external power source and a storage battery by causing a heating resistor to generate heat due to ingress of liquid being detected by a means for detecting ingress of liquid including water and an electrolyte.

Further, another example of a protective function is a forced discharge mechanism for discharging a storage battery by forcibly establishing conduction between a pair of power transport paths that are respectively connected to a positive electrode and a negative electrode of the storage battery.

For example, JP 2008-27889A (Patent Document 2) discloses a secondary battery in which one side portion of a heat shrinkable tube is fixed, the other side portion thereof is coupled to a wire connecting portion so as to cause a current to flow or be interrupted due to a change in the length when it varies due to heat, the wire connecting portion of a safety switch is connected to positive and negative electrode terminals of a battery cell, and at least one resistance member is connected between the wire connecting portion and the electrode terminals.

However, with the battery pack described in Patent Document 1, although power supply between the external power source and the storage battery can be interrupted by blowing the thermal fuse connected in series to the power transport path between the external power source and the storage battery with the means for detecting ingress of liquid, this battery pack is not compatible with forced discharge in which conduction is forcibly established between the pair of power transport paths that are respectively connected to the positive and negative electrodes of the storage battery. Accordingly, an electric leakage or a short circuit is caused between the positive and negative electrode terminals of the storage battery by getting wet, which leads to a problem such as generation of heat, and the battery pack is thus lacking in terms of safety when an abnormal condition such as getting wet occurs.

With regard to this point, for example, a configuration for, with use of a sensor for detecting ingress of liquid, interrupting the connection between the external power source and the storage battery and forcibly establishing conduction (connection to a discharger) between transport paths connected to the storage battery is conceivable. However, the following problems may arise in this case (see FIG. 13).

FIG. 13 is a conceptual diagram of a system that, with use of a sensor Sd for detecting ingress of liquid L, interrupts the connection between an external power source P and a storage battery Bd, and connects a discharger Gd to the storage battery Bd when the liquid L enters.

In the system shown in FIG. 13, a control device CN performs switching control on a switching means SW for switching between a charging state in which the connection between the external power source P and the storage battery Bd is established and a discharging state in which the storage battery Bd and the discharger Gd are connected, and when it is determined that the liquid L has entered based on an electrical signal from the sensor Sd for detecting ingress of the liquid L, the control device CN interrupts the connection between the external power source P and the storage battery Bd that are in the charging state, and switches the discharge battery Bd to the discharger Gd.

However, according to the system shown in FIG. 13, in order to interrupt the connection between the external power source P and the storage battery Bd that are in the charging state and switch the storage battery Bd to the discharger Gd, it is necessary to use an electrical control configuration in which the control device CN is operated based on information transmitted from the sensor Sd indicating that the liquid L has entered, a computing means of the control device CN performs computational processing and transmits a signal to the switching means SW, or a circuit connected to the discharger Gd is operated.

Further, with the secondary battery described in Patent Document 2, although the storage battery can be discharged by forcibly establishing conduction between the pair of power transport paths that are respectively connected to the positive and negative electrodes of the storage battery, the storage battery is discharged after the positive and negative electrodes of the storage battery get wet or the like. In addition, it is necessary to wait until the heat shrinkable tube shrinks by reaching a predetermined temperature or higher for causing discharge, and consequently an electric leakage or a short circuit is caused between the positive and negative electrode terminals of the storage battery by getting wet or the like, which leads to the lack of safety when an abnormal condition such as getting wet occurs.

In view of this, an object of the present invention is to provide a forced discharge mechanism for a storage battery and a safety switch device that can improve safety when an abnormal condition such as getting wet occurs, without using an electrical control configuration.

### SUMMARY OF THE INVENTION

In order to solve the above problems, the present invention provides a forced discharge mechanism for a storage battery for forcibly establishing conduction between a pair of power transport paths that are respectively connected to a positive electrode and a negative electrode of the storage battery, the mechanism including an electric resistor for establishing conduction between the power transport paths, and the electric resistor is movable due to a buoyant force of liquid that has entered.

The concept of “liquid” in the present invention includes electrolytes such as flood water and water from an overflowing river due to heavy rain, torrential rain or the like, and sea water.

According to the forced discharge mechanism for a storage battery according to the present invention, the electric resistor is moved due to the buoyant force of liquid that has entered. Accordingly, conduction between the power transport paths can be established by the moved electric resistor upon ingress of liquid, which enables voluntary and automatic discharge of the storage battery. Thus, even if ingress of liquid (e.g., getting wet due to a flood etc.) occurs, the occurrence of an electric leakage or a short circuit due to liquid can be suppressed between the positive and negative electrode terminals of the storage battery, and consequently it is possible to suppress heat generation between the electrode terminals of the storage battery. Moreover, it is possible to reduce the amount of electric power stored in the storage battery by causing a current to flow between the power transport paths without using an electrical control configuration, since the buoyant force of liquid hat has entered is utilized. Furthermore, when ingress of liquid is eliminated, the state between the power transport paths can be returned (or revert) to the original non-conductive state.

It is preferable that the forced discharge mechanism for a storage battery according to the present invention is provided in a product for use outdoors.

In this case, the forced discharge mechanism can effectively cope with the occurrence of ingress of liquid, which tends to occur outdoors.

As a specific aspect of the forced discharge mechanism according to the present invention, an aspect in which the mechanism includes a float portion that has a lower relative specific gravity than a specific gravity of liquid, discharge paths each having a terminal at one end that is connected to a different one of the power transport paths, and a terminal at the other end that is connectable to the electric resistor, and a guide portion for guiding the float portion on which the electric resistor is provided can be given as an example.

Here, the relative specific gravity of the float portion means the specific gravity of the entire float portion. Specifically, the concept of the float portion includes an element with its inside being hollow and the specific gravity of the entirety thereof being smaller than the specific gravity of liquid, and also an element constituted with a material whose true density is lower than liquid and that floats in liquid.

In this aspect, since the guide portion guides the float portion on which the electric resistor is provided, conduction can be stably and reliably established between the power transport paths.

An aspect in which the forced discharge mechanism for a storage battery according to the present invention includes a case for covering the storage battery can be give as an example.

In this aspect, since the storage battery is covered with the case, ingress of liquid from the outside can be suppressed.

It is preferable that in the forced discharge mechanism for a storage battery according to the present invention, a surface of liquid when the electric resistor is caused to come into contact with the pair of terminals at the other end of the discharge paths is at a lower position than positions of electrode terminals of the storage battery.

In this aspect, a configuration is adopted in which the surface of liquid is at a lower position than the positions of the electrode terminals of the storage battery, and conduction between the power transport paths can be reliably established before an electric leakage or a short circuit due to liquid occurs between the electrode terminals of the storage battery, and thus safety can be further improved.

It is preferable that in the forced discharge mechanism for a storage battery according to the present invention, a liquid-tight structure is provided between the float portion and the guide portion.

In this aspect, the liquid-tight structure can effectively prevent liquid from infiltrating to the contact portions of the pair of terminals at the other end of the discharge paths that come in contact with the electric resistor.

It is preferable that in the forced discharge mechanism for a storage battery according to the present invention, the guide portion covers, in a liquid-tight manner, at least contact portions of the pair of terminals at the other end of the discharge paths that come in contact with the electric resistor.

In this aspect, since the guide portion covers at least the contact portions in a liquid-tight manner, ingress of liquid to the contact portions can be reliably prevented.

It is preferable that the forced discharge mechanism for a storage battery according to the present invention includes a heat dissipation structure for dissipating heat generated by the electric resistor.

In this aspect, the rise of the electric resistance of the electric resistor due to heat generated therein can be suppressed, and thereby deterioration of the discharge properties due to the rise of the electric resistance of the electric resistor can be suppressed.

More preferably, an aspect in which the heat dissipation structure dissipates heat generated by the electric resistor from an entire surface of the forced discharge mechanism can be given as an example.

In this aspect, the rise of the electric resistance of the electric resistor due to heat generated therein can be further suppressed, and the discharge effect can be further improved.

Although it is preferable that discharge of the storage battery is promptly performed, if the electric power capacity of the storage battery and the heat generation state of the electric resistor are taken into consideration, it is preferable that the electric resistor has a resistance value that enables discharge of the storage battery for 1000 seconds to 10 hours.

It is preferable that the forced discharge mechanism for a storage battery according to the present invention includes a capacitor that is connected to the discharge paths such that the capacitor is in parallel with the electric resistor that comes in contact with the discharge paths.

In this aspect, it is possible to avoid an excessive discharge current flowing into the electric resistor when the electric resistor comes in contact with the pair of terminals at the other end of the discharge paths.

Although the capacitor may have any rating as long as an excessive current to the electric resistor can be avoided, it is preferable that the capacitor has a withstand voltage of 100V or more and a capacitance of 10 pF to 1000 pF, for example.

With the forced discharge mechanism for a storage battery according to the present invention, in the case where, for example, the external power source that supplies electric power to the storage battery is connected to the storage battery via the power transport paths, conduction between the electrodes of the external power source is established following establishment of conduction between the power transport paths due to ingress of liquid.

In view of this, the present invention also provides a safety switch device that is provided with the forced discharge mechanism for a storage battery according to the present invention, and is for interrupting the power transport paths that are connected between an external power source and the storage battery, the safety switch device including an interrupting device that is capable of interrupting a connection between the external power source and a conduction portion on each of the power transport paths brought into conduction by the forced discharge mechanism, and the interrupting device interrupts the connection between the conduction portions and the external power source following ingress of liquid.

According to the safety switch device according to the present invention, the connection between the external power source and the conduction portions on the power transport paths can be automatically interrupted by the interrupting device following ingress of liquid. Accordingly, it is possible to avoid conduction between the electrodes of the external power source being established following establishment of conduction between the power transport paths by the forced discharge mechanism.

It is preferable that in the safety switch device according to the present invention, the interrupting device interrupts the connection between the external power source and the conduction portions on the power transport paths, prior to the electric resistor bringing the pair of terminals at the other end of the discharge paths into conduction following ingress of liquid.

In this aspect, before conduction between the electrodes of the external power source is established due to conduction between the power transport paths being established by the forced discharge mechanism, the connection between the external power source and the conduction portions on the power transport paths can be interrupted, and accordingly it is possible to reliably avoid conduction between the electrodes of the external power source being established following establishment of conduction between the power transport paths by the forced discharge mechanism.

(a) First Aspect

In the safety switch device according to the present invention, as a specific first aspect of the interrupting device, an aspect in which the interrupting device is capable of switching between a connected state in which the connection between the external power source and the conduction portions on the power transport paths is established, and an interrupted state in which the connection between the external power source and the conduction portions on the power transport paths is interrupted can be given as an example.

In this first aspect, since the interrupting device can switch between the connected state and the interrupted state between the external power source and the conduction portions on the power transport paths, the interrupting device can switch the connected state to the interrupted state when liquid enters, and can switch the interrupted state to the connected state when ingress of liquid is eliminated so that conduction between the power transport paths established by the forced discharge mechanism is canceled, which enables return from the interrupted state to the connected state.

As one specific aspect of the first aspect, an aspect in which the interrupting device includes a control switch for switching between an ON state and an OFF state based on an electrical signal, and a control device for controlling a switching operation of the control switch, the control switch is connected in series between the external power source and at least one of the conduction portions on the power transport paths, and the control device switches the control switch to the OFF state if it is determined that liquid has entered based on a detection result obtained by a detection sensor for detecting ingress of liquid can be given as an example.

In this aspect, the control device can reliably switch between the interrupted state and the connected state. Furthermore, it is possible to adjust the time to interrupt the connection between the external power source and the conduction portions on the power transport paths.

Further, it is preferable that the control device is provided on the power transport paths between the conduction portions and the external power source.

In this aspect, the electric power from the external power source can be reliably supplied to the control device.

As another specific aspect of the first aspect, in the case where the forced discharge mechanism is provided with the float portion, the discharge paths, and the guide portion, an aspect in which the interrupting device includes a gravity switch having a switch portion that maintains an ON state due to gravity and enters an OFF state by being pushed up against gravity, and an actuator portion for pushing up the switch portion, the switch portion is connected in series between the external power source and at least one of the conduction portions on the power transport paths, and the actuator portion operates in coordination with the float portion when the float portion rises up due to the buoyant force following ingress of liquid can be given as an example.

In this aspect, it is possible to interrupt the connection between the external power source and the conduction portions on the power transport paths utilizing the forced discharge mechanism provided with the float portion, the discharge paths, and the guide portion.

In such an aspect, the actuator portion may not connected to either the switch portion or the float portion and the electric resistor, or may be connected to one of the switch portion, the float portion, the electric resistor, and the float portion and the electric resistor.

For example, in the case where the actuator portion is not coupled to either the switch portion or the float portion and/or the electric resistor, and in the case where the actuator portion is coupled to either the switch portion or the float portion and/or the electric resistor, it is possible to suppress the influence from the float portion shaking due to waves generated at the surface of liquid being exerted on the connected state between the conduction portions and the external power source. Further, in the case where the actuator portion is coupled to both the switch portion and the float portion and/or the electric resistor, the float portion and the switch portion can be reliably caused to operate in coordination with each other via the actuator portion.

(b) Second Aspect

In the safety switch device according to the present invention, as a specific second aspect of the interrupting device, an aspect in which the interrupting device has a conductive connecting body that is connected in series between the external power source and at least one of the conduction portions on the power transport paths, and the connecting body is split between the external power source and the storage battery following ingress of liquid can be given as an example.

In this second aspect, it is possible to interrupt the connection between the external power source and the conduction portions on the power transport paths with a simple configuration.

As one specific aspect of the second aspect, an aspect in which the electric resistor is a heating resistor, and the connecting body is a thermal fuse that is blown due to heat generated by the heating resistor can be given as an example.

In this aspect, with a heating resistor serving as the electric resistor, the thermal fuse can interrupt the connection between the external power source and the conduction portions on the power transport paths utilizing heat generated by the heating resistor.

In such an aspect, it is preferable that a heat insulating structure for insulating heat generated by the heating resistor is provided.

In this aspect, the temperature rise efficiency of the thermal fuse can be improved, and thus the connection between the external power source and the conduction portions on the power transport paths can be interrupted earlier.

As another specific aspect of the second aspect, in the case where the forced discharge mechanism is provided with the float portion, the discharge paths, and the guide portion, an aspect in which the interrupting device includes a splitting member for splitting the connecting body, the connecting body is an split electric conductor to be split that is splittable by the splitting member, and the splitting member splits the split electric conductor to be split when the float portion rises up due to the buoyant force following ingress of liquid can be given as an example.

In this aspect, the connection between the external power source and the conduction portions on the power transport paths can be interrupted utilizing the forced discharge mechanism provided with the float portion, the discharge paths, and the guide portion.

The safety switch device according to the present invention can be suitably used in a solar power generation system interconnected with a power system or in a fuel cell system interconnected with an power system. That is, in the safety switch device according to the present invention, the external power source may be a solar cell in a solar power generation system that is interconnected with a power system or a fuel cell in a fuel cell system that is interconnected with a power system.

Further, in the safety switch device according to the present invention, the storage battery may be a power source for an electric vehicle or a hybrid electric vehicle.

As described above, according to the forced discharge mechanism for a storage battery and the safety switch device according to the present invention, it is possible to improve safety when an abnormal condition such as getting wet occurs, without using an electrical control configuration.

Specifically, according to the forced discharge mechanism for a storage battery and the safety switch device according to the present invention, since the electric resistor is moved due to the buoyant force of liquid that has entered, conduction between the power transport paths can be established by the moved electric resistor upon ingress of liquid, which enables voluntary and automatic discharge of the storage battery. Thus, even if ingress of liquid (e.g., getting wet due to a flood etc.) occurs, the occurrence of an electric leakage or a short circuit due to liquid can be suppressed between the positive and negative electrode terminals of the storage battery, and consequently it is possible to suppress heat generation between the electrode terminals of the storage battery. Moreover, it is possible to reduce the amount of electric power stored in the storage battery by causing a current to flow between the power transport paths without using an electrical control configuration, since the buoyant force of liquid hat has entered is utilized. Furthermore, when ingress of liquid is eliminated, the state between the power transport paths can be returned (or revert) to the original non-conductive state.

Further, according to the safety switch device according to the present invention, the connection between the external power source and the conduction portions on the power transport paths can be automatically interrupted by the interrupting device following ingress of liquid. Accordingly, it is possible to avoid conduction between the electrodes of the external power source being established following establishment of conduction between the power transport paths by the forced discharge mechanism.

### BRIEF DESCRIPTION OF THE DRAWINGS

FIG. 1 is a diagram showing an example in which a forced discharge mechanism for a storage battery according to a first embodiment of the present invention is applied to a power generation system.

FIG. 2 is a schematic explanatory diagram illustrating another example of a liquid-tight structure provided between a float portion and a guide portion.

FIG. 3 is a schematic explanatory diagram illustrating another example in which at least contact portions of discharge paths that come in contact with an electric resistor are covered in a liquid-tight manner, where FIG. 3A is a diagram showing a state in which a second flexible film, which is another example, is provided together with an insulating seal material, and FIG. 3B is a diagram showing a state in which the second flexible film, which is another example, is provided together with a first flexible film.

FIG. 4 is a schematic explanatory diagram illustrating an example of the float portion covered with a heat dissipation member.

FIG. 5 is a schematic explanatory diagram showing an example in which a safety switch device according to a second embodiment of the present invention is applied to a power generation system.

FIG. 6 is a schematic diagram illustrating water detection operation of a wetness sensor.

FIG. 7 is a diagram showing an example in which a safety switch device according to a third embodiment of the present invention is applied to a power generation system.

FIG. 8 is a diagram showing an example in which a safety switch device according to a fourth embodiment of the present invention is applied to a power generation system.

FIG. 9 is a diagram showing an example in which a safety switch device according to a fifth embodiment of the present invention is applied to a power generation system.

FIG. 10 is a diagram showing an example in which a safety switch device according to a sixth embodiment of the present invention is applied to a power generation system.

FIG. 11 is a diagram showing an example in which a safety switch device according to a seventh embodiment of the present invention is applied to a power generation system.

FIG. 12 is a schematic diagram of a conductive material to be split that has a groove portion that is laterally viewed.

FIG. 13 is a conceptual diagram of a system that, with use of a sensor for detecting ingress of liquid, interrupts the connection between an external power source and a storage battery and connects a discharger to the storage battery when liquid enters.

### DESCRIPTION OF REFERENCE NUMERALS

1 Solar power generation system or Fuel cell system
10a Power generating portion
10b Power system
30 Battery module
31, 32 Power transport path
31a, 32a Conduction portion
40 Control device
50 Detection sensor
50a Water detection sensor
50b Current flow detection sensor
100 Forced discharge mechanism
101 Float portion
110 Electric resistor
110a Heating resistor
131a, 132a Pair of terminals at one end
131b, 132b Pair of terminals on other end
131c, 132c Contact portion
131, 132 Discharge path
140 Guide portion
150 Case
160 Liquid-tight structure
161 Insulating seal material (another example of liquid-tight structure)
162 First flexible seal (another example of liquid-tight structure)
163 Water-tight plug
164 Second flexible seal
181, 182 Heat insulating structure
170 Capacitor
20 power conversion device
200a to 200f Safety switch device
210a to 210f Interrupting device
211 Control switch
212 Gravity switch
213 Switch portion
214 Actuator portion
215 Connecting body
215a Thermal fuse (example of connecting body)
215b Split electric conductor (another example of connecting body)
216 Splitting member
B Battery unit (example of storage battery)
B1 Positive electrode terminal
B2 Negative electrode terminal
L Water (example of liquid)
LL Water surface
P External power source

### DESCRIPTION OF EMBODIMENTS

Hereinafter, embodiments according to the present invention are described with reference to drawings. Note that the embodiments below are examples embodying the present invention, and are not intended to limit the technical scope of the present invention.

### First Embodiment

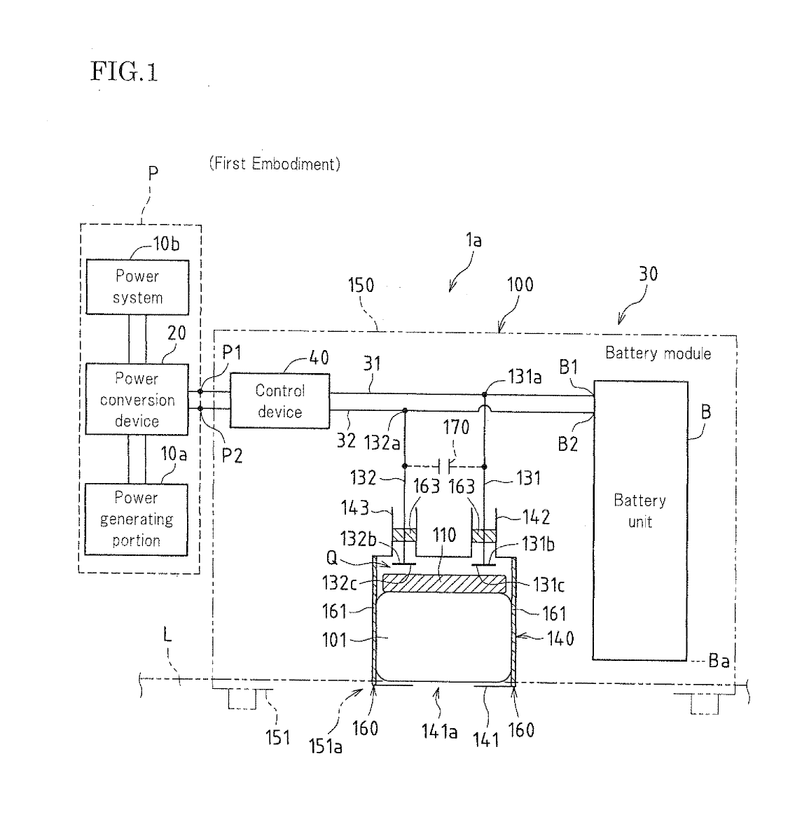

FIG. 1 is a diagram showing an example in which a forced discharge mechanism 100 for a storage battery B according to a first embodiment of the present invention is applied to a power generation system 1a.

The power generation system 1a shown in FIG. 1 converts direct current power from a power generating portion 10a into alternating current power in a power conversion device 20 (here, inverter), supplies the alternating current power obtained by conversion to a power system lob, and is interconnected with the power system 10b. Further, the power generation system 1a supplies direct current power from the power generating portion 10a to the storage battery B. Note that the power generating portion 10a, the power system 10b, and the power conversion device 20 operate as an external power source P.

The power generating portion 10a may be an electric power device such as a solar cell that directly converts natural energy such as sunlight into electric power or an electric power device such as a fuel cell that can continuously extracts electric power with fuel kept supplied. Here, the storage battery B is a battery unit including a plurality of battery cells.

The power generation system 1a interconnected with the power system 10b is an autonomy-enhanced solar power generation system in the case where the power generating portion 10a is a solar cell, and the power generation system 1a is a fuel cell system in the case where the power generating portion 10a is a fuel cell, for example.

The power generation system 1a, which is for use outdoors, is provided with the power generating portion (a solar cell or a fuel cell, here) 10a, the power conversion device 20 for converting direct current power from the power generating portion 10a into alternating current power, a battery module 30 that has a protective function, and a control device 40 that performs overall control of the power generation system 1a.

The power conversion device 20 is provided between the power generating portion 10a and the power system 10b, and is an interconnection inverter that converts direct current power into alternating current power having a predetermined frequency. Further, the power conversion device 20 is connected to the control device 40. The control device 40 is connected to the storage battery B via a pair of power transport paths 31 and 32.

The power generation system 1a is interconnected with the power system 10b, and controls the power conversion device 20 in response to an instruction from the control device 40 so as to store electric power generated by the power generating portion 10a in the storage battery B when the amount of generated electric power is large such as during the daytime.

The battery module 30 is provided with the forced discharge mechanism 100 for the storage battery B. Note that the battery module 30 may be used as a power source for an electric vehicle or a hybrid electric vehicle.

The control device 40 is provided with a processing unit (not shown) such as a CPU (central processing unit), and a storage unit (not shown). A storage unit includes storage memories such as a ROM (read only memory) and a RAM (random access memory), and stores various control programs and data such as necessary functions and tables. The power generation system 1a controls various constituent elements by the processing unit of the control device 40 loading a control program stored in the ROM of the storage unit in advance in the RAM of the storage unit and executing the program.

The forced discharge mechanism 100 forcibly establishes conduction between the pair of power transport paths 31 and 32 that are respectively connected to a positive electrode terminal B1 and a negative electrode terminal B2 of the storage battery B.

Further, the forced discharge mechanism 100 has an electric resistor 110 for establishing conduction between the power transport paths 31 and 32.

The forced discharge mechanism 100 is configured such that the electric resistor 110 is movable due to the buoyant force of liquid (hereinafter, referred to as water) L that has entered into the inside of the forced discharge mechanism 100.

Specifically, on the assumption of the occurrence of abnormalities associated with water such as, for example, the overflowing of a river, a flood and storm surge, the forced discharge mechanism 100 allows the electric resistor 110 to come in contact with a pair of terminals 131b and 132b (specifically, contact portions 131c and 132c on the lower face side of the pair of terminals 131b and 132b facing the water L) from the power transport paths 31 and 32 following ingress of the water L, thereby establishing conduction between the power transport paths 31 and 32. Note that with regard to the pair of terminals 131b and 132b, the upper face side shown in FIG. 1 is constituted as a terminal, and the lower surface side is constituted as the contact portions 131c and 132c that come in contact with water.

Specifically, the forced discharge mechanism 100 is provided with a float portion 101 that receives the buoyant force of the water L, discharge paths 131 and 132 for establishing conduction between the power transport paths 31 and 32, and a guide portion 140 that guides the float portion 101.

The float portion 101 has a lower relative specific gravity than the specific gravity of the water L, and is here a hollow sealing member having air inside. Here, the material of the float portion 101 is an electrical insulation material.

The electric resistor 110 is a member that has electric resistance with a current flow portion being exposed on at least the upper portion thereof, and is provided on the upper portion of the float portion 101. A plurality of the electric resistors 110 may be disposed on the float portion 101.

With regard to the discharge paths 131 and 132, a pair of terminals 131a and 132a at one end are respectively connected to the power transport paths 31 and 32, and the pair of terminals 131b and 132b at the other end (specifically, the contact portions 131c and 132c) face the electric resistor 110 on the upper portion of the float portion 101 disposed below.

The guide portion 140 guides the float portion 101 provided with the electric resistor 110.

Specifically, the guide portion 140 is configured to guide such that the electric resistor 110 provided on the float portion 101 that rises up due to the buoyant force following ingress of the water L comes in contact with the pair of terminals 131b and 132b (specifically, the contact portions 131c and 132c) at the other end of the discharge paths 131 and 132, thereby bringing the pair of terminals 131b and 132b into conduction.

Specifically, the guide portion 140 is a member having a tubular shape with a bottom or a box like shape for supporting the float portion 101 to be slidable in the vertical direction, and has a water passing port 141a in a bottom plate 141 through which the water L can enter.

Further, the forced discharge mechanism 100 is provided with a case 150 for covering the storage battery B. In order to suppress ingress of the water L to the water passing port 141a of the guide portion 140, and avoid getting wet and ingress of water due to a rainstorm, the case 150 is here an exterior cover of the battery module 30 for covering the entire forced discharge mechanism 100. The case 150 has an opening portion 151a in a bottom portion 151 through which the water L can enter.

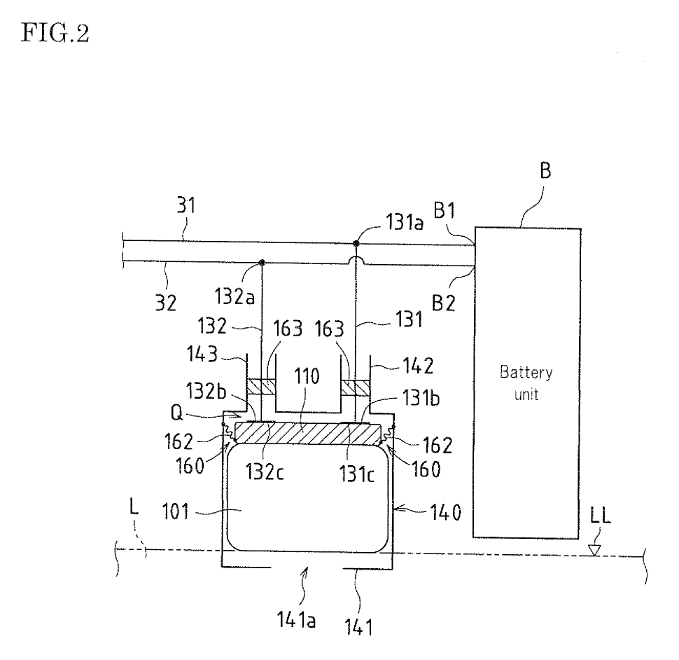

The forced discharge mechanism 100 is configured such that the water surface (see a chain line LL in FIGS. 2 to 4 described later) when the electric resistor 110 comes in contact with the pair of terminals 131b and 132b (specifically, the contact portions 131c and 132c) at the other end of the discharge paths 131 and 132 is positioned below the positions of the electrode terminals B1 and B2 of the storage battery B.

Here, the water passing port 141a of the guide portion 140 is disposed below a lower end position Ba of the storage battery B installed in the battery module 30.

When abnormalities associated with water such as, for example, the overflowing of a river, a flood and storm surge occur, the forced discharge mechanism 100 for the storage battery B according to the first embodiment described above has the opening portion 151a in the case 150 of the battery module 30, and also the water passing port 141a in the guide portion 140, and accordingly the float portion 101 rises up due to the water L that has entered through the water passing port 141a from the opening portion 151a, and the electric resistor 110 disposed on the upper portion of the float portion 101 is electrically coupled in the state where the power transport paths 31 and 32 between the storage battery B and the control device 40 are short-circuited, thereby discharging the storage battery B.

Specifically, the float portion 101 inside the case 150 rises up due to the water L that has entered into the inside of the battery module 30, and the electric resistor 110 disposed on the upper portion of the float portion 101 electrically comes in contact with the pair of terminals 131b and 132b (specifically, the contact portions 131c and 132c) at the other end of the discharge paths 131 and 132 from the storage battery B in the state of being connected thereto so as to cause a current to flow between the power transport paths 31 and 32, thereby reducing the amount of electric power (electrical energy) stored in the storage battery B.

If the water L comes in contact with the contact portions 131c and 132c of the discharge paths 131 and 132 that come in contact with the electric resistor 110, in the case where, for example, electrolysis of the water L occurs, the internal pressure of a space Q in which the contact portions 131c and 132c exist increases, and the rising-up operation of the float portion 101 is suppressed, which makes it difficult to perform a forced discharge operation, and besides there is a possibility that discharge may be discontinued even if a forced discharge operation is performed.

From such a viewpoint, a liquid-tight structure 160 is provided between the float portion 101 and the guide portion 140. Here, the liquid-tight structure 160 is configured to seal, in a water-tight manner, a gap portion (sliding portion) between the float portion 101 and the guide portion 140 with an insulating seal material 161 such as a silicon resin.

FIG. 2 is a schematic explanatory diagram illustrating another example of the liquid-tight structure 160 provided between the float portion 101 and the guide portion 140.

As shown in FIG. 2, the liquid-tight structure 160 may have a structure for water-tight sealing with a first flexible film 162 provided between the float portion 101 and the guide portion 140 so as to allow the float portion 101 to rise up due to ingress of the water L, instead of the insulating seal material 161.

Further, as shown in FIG. 1, instead of the liquid-tight structure 160, or/and in addition to the liquid-tight structure 160 (in addition to the liquid-tight structure 160, here), the guide portion 140 is configured to cover, in a liquid-tight manner, at least the contact portions 131c and 132c of the pair of terminals 131b and 132b at the other end of the discharge paths 131 and 132 that come in contact with the electric resistor 110. Here, a configuration is adopted in which gap portions in the guide portion 140 in introducing portions 142 and 143 for introducing the discharge paths 131 and 132 around the discharge paths 131 and 132 are sealed with water-tight plugs 163 in a water-tight manner.

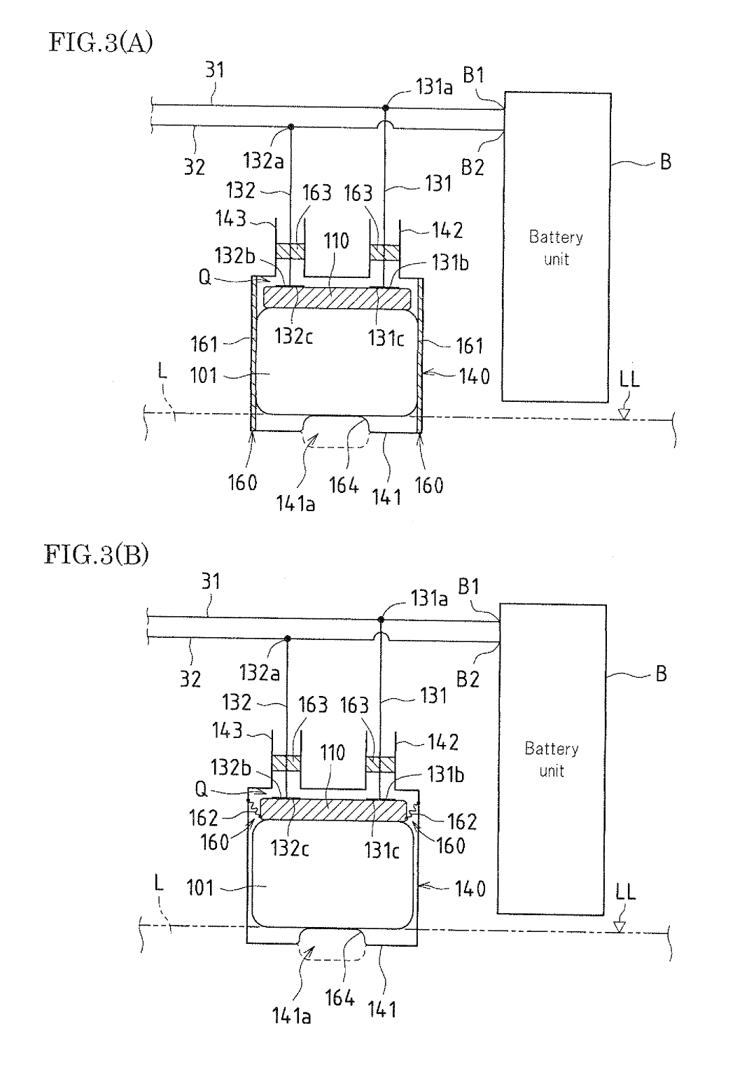

FIG. 3 is a schematic explanatory diagram illustrating another example in which at least the contact portions 131c and 132c of the discharge paths 131 and 132 that come in contact with the electric resistor 110 are covered in a liquid-tight manner, and includes FIGS. 3A and 3B. FIG. 3A shows a state in which a second flexible film 164, which is another example, is provided together with the insulating seal material 161, and FIG. 3B shows a state in which the second flexible film 164, which is another example, is provided together with the first flexible film 162.

As shown in FIG. 3, the guide portion 140 may be provided with the second flexible film 164 for covering the water passing port 141a of the guide portion 140 so as to allow the float portion 101 to rise up due to ingress of the water L.

Further, the forced discharge mechanism 100 may be provided with a heat dissipation structure for dissipating heat generated by the electric resistor 110.

The float portion 101 can be constituted using a material selected from materials with excellent thermal conductivity that serve as an electric insulator and promote heat transfer to the float portion 101 in order to prevent the electric resistance value of the electric resistor 110 from changing due to an increase in the temperature of the electric resistor 110. Further, an outer circumferential face of the float portion 101 including at least a portion that comes in contact with the electric resistor 110 may be covered with a heat dissipation member having excellent thermal conductivity.

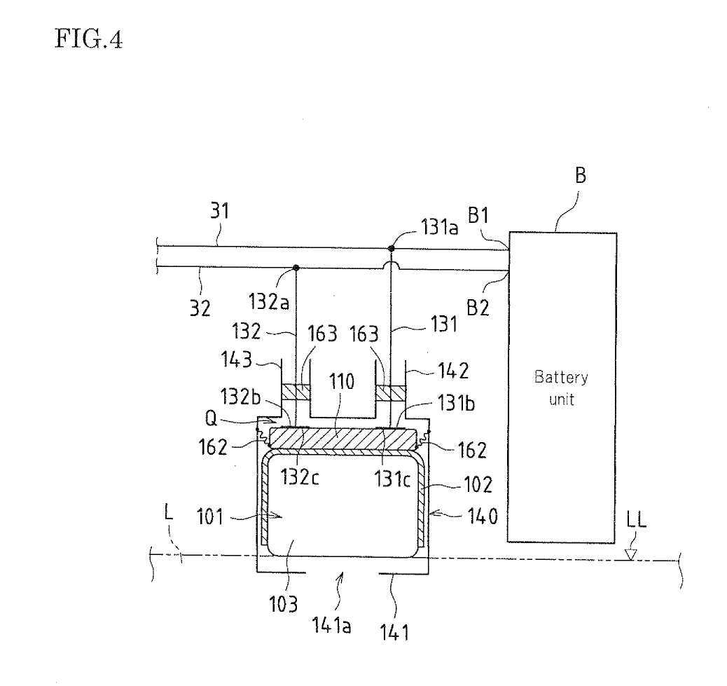

FIG. 4 is a schematic explanatory diagram illustrating an example of the float portion 101 covered with a heat dissipation member 102. Note that FIG. 4 shows a state in which the first flexible film 162 is provided.

The heat dissipation member 102 formed with the material having excellent thermal conductivity covers a float portion main body 103 so as to cover the portion that comes in contact with the electric resistor 110, as shown in FIG. 4. The float portion 101 is constituted by the heat dissipation member 102 and the float portion main body 103.

Although an inorganic compound such as Carborundum, boron nitride or diamond may be used as the material having excellent thermal conductivity, a thermally conductive resin can be suitably used in terms of formability or processability in consideration of a buoyant force structure. Examples of a suitable thermally conductive resin material include highly thermally conductive resins G146Z1 and T121J1 manufactured by Idemitsu Kosan Co., Ltd.

Further, it is preferable that the forced discharge mechanism 100 dissipates heat generated by the electric resistor 110 from the entire surface of the case 150.

For example, it is preferable that the guide portion 140 that includes the float portion 101 has a heat dissipation structure with excellent heat dissipation properties. More specifically, the guide portion 140 may have a heat dissipation structure whose external portion is given a shape like heat dissipating fins for the CPU that are employed in computers such as personal computers, for example.

Here, the electric resistor 110 has a resistance value that enables discharge of the storage battery B for 1000 seconds to 10 hours. Note that assuming that the resistance value of the electric resistor 110 is R, the voltage of the storage battery B is V, the current that flows through the electric resistor 110 is I, the amount of electric power that can be stored in the storage battery B is E, and the discharge time period is T, a resistance value R can be obtained using the following equations.

R=(V²×T)/E or R=E/(I²×T)

Further, as shown in FIG. 1, the forced discharge mechanism 100 may be provided with a capacitor 170 for preventing an excess current in order to suppress an excess current in the contact portions 131c and 132c when the electric resistor 110 comes in contact with the pair of terminals 131b and 132b (specifically, the contact portions 131c and 132c) at the other end of the discharge paths 131 and 132. This capacitor 170 can be connected to the discharge paths 131 and 132 (see the dashed line in FIG. 1) so as to be in parallel with the electric resistor 110 that comes in contact with the discharge paths 131 and 132. For example, the capacitor 170 is a capacitor having a withstand voltage of 100V or more and a capacitance of 10 pF to 1000 pF.

According to the first embodiment, since the electric resistor 110 can be moved by the buoyant force of the water L that has entered, conduction can be established between the power transport paths 31 and 32 by the moved electric resistor 110 upon ingress of the water L, which enables voluntary and automatic discharge of the storage battery B. Accordingly, even if ingress of the water L occurs (e.g., getting wet due to a flood, etc.), the occurrence of an electric leakage or a short circuit due to the water L can be suppressed between the positive electrode terminal B1 and the negative electrode terminal B2 of the storage battery B, and consequently it is possible to suppress heat generation between the electrode terminals B1 and B2 of the storage battery B. Moreover, it is possible to reduce the amount of electric power (electrical energy) stored in the storage battery B by causing a current to flow between the power transport paths 31 and 32 without using an electrical control configuration since the buoyant force of the water L that has entered is utilized. Furthermore, when ingress of the water L is eliminated, the state between the power transport paths 31 and 32 can be returned (or revert) to the original non-conductive state.

Further, the forced discharge mechanism 100 can effectively cope with the occurrence of ingress of the water L to the inside, which tends to occur outdoors.

Further, the guide portion 140 guides the float portion 101 that rises up due to the buoyant force following ingress of the water L such that the electric resistor 110 provided on the float portion 101 comes in contact with the pair of terminals 131b and 132b (specifically, the contact portions 131c and 132c) at the other end of the discharge paths 131 and 132, thereby bringing the pair of terminals 131b and 132b at the other end into conduction. Thus, conduction can be stably and reliably established between the power transport paths 31 and 32.

Further, since the storage battery B is covered with the case 150, ingress of the water L from the outside can be suppressed.

Further, the forced discharge mechanism 100 is configured such that the water surface LL when the electric resistor 110 comes in contact with the discharge paths 131 and 132 is positioned below the positions of the electrode terminals B1 and B2 of the storage battery B, and thus before an electric leakage or a short circuit due to the water L occurs between the electrode terminals B1 and B2 of the storage battery B, conduction can be reliably established between the power transport paths 31 and 32, and safety can be further improved.

Further, the liquid-tight structure 160 can effectively prevent the water L from infiltrating up to the contact portions 131c and 132c of the discharge paths 131 and 132 that come in contact with the electric resistor 110.

Further, the guide portion 140 covers, in a liquid-tight manner, at least the contact portions 131c and 132c of the discharge paths 131 and 132 that come in contact with the electric resistor 110, and thus ingress of the water L up to the contact portions 131c and 132c can be reliably prevented.

Further, in the case where the float portion 101 is constituted using a material selected from materials having excellent thermal conductivity, and/or the float portion 101 is covered with the heat dissipation member 102, it is possible to easily transfer heat from the electric resistor 110 to the water L that has entered via the float portion 101. Accordingly, the rise of the electric resistance of the electric resistor 110 due to heat generated therein can be suppressed, and consequently deterioration of the discharge properties due to the rise of the electric resistance of the electric resistor 110 can be suppressed. Further, in the case where heat generated by the electric resistor 110 is dissipated from the entire surface of the case 150, the rise of the electric resistance of the electric resistor 110 due to heat generated therein can be further suppressed, and the discharge effect can be further improved.

Further, in the case where the capacitor 170 is connected to the discharge paths 131 and 132 so as to be in parallel with the electric resistor 110 that comes in contact with the discharge paths 131 and 132, when the electric resistor 110 comes in contact with the pair of terminals 131b and 132b (specifically, the contact portions 131c and 132c) at the other end of the discharge paths 131 and 132, it is possible to avoid situations such as occurrence of sparks between the electric resistor 110 and the pair of terminals 131b and 132b (specifically, the contact portions 131c and 132c) due to a discharge current that starts to flow into the electric resistor 110 becoming excessive, and welding of the electric resistor 110 and the pair of terminals 131b and 132b (specifically, the contact portions 131c and 132c) due to the influence thereof, for example.

In the first embodiment, if the storage battery B is in the discharging state, although operation is performed so as to reduce the amount of electric power (electrical energy) stored in the storage battery B, conduction is established between electrode terminals P1 and P2 connected to the power generating portion 10a and the power system 10b. It is desirable that the electric power from the power generating portion 10a and the power system 10b may not be supplied to the storage battery B at this time due to operation of charging the storage battery B.

In view of this, safety switch devices 200a to 200f according to second to seventh embodiments below are applicable to power generation systems 1b to 1g.

### Second Embodiment

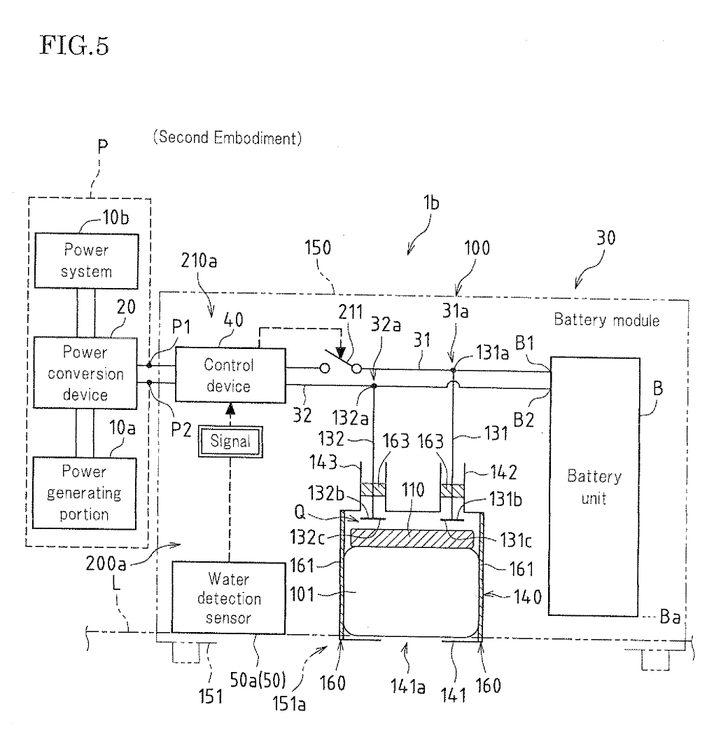

FIG. 5 is a diagram showing an example in which a safety switch device 200a according to a second embodiment of the present invention is applied to a power generation system 1b.

The power generation system 1b shown in FIG. 5 is provided with the safety switch device 200a in the power generation system 1a shown in FIG. 1.

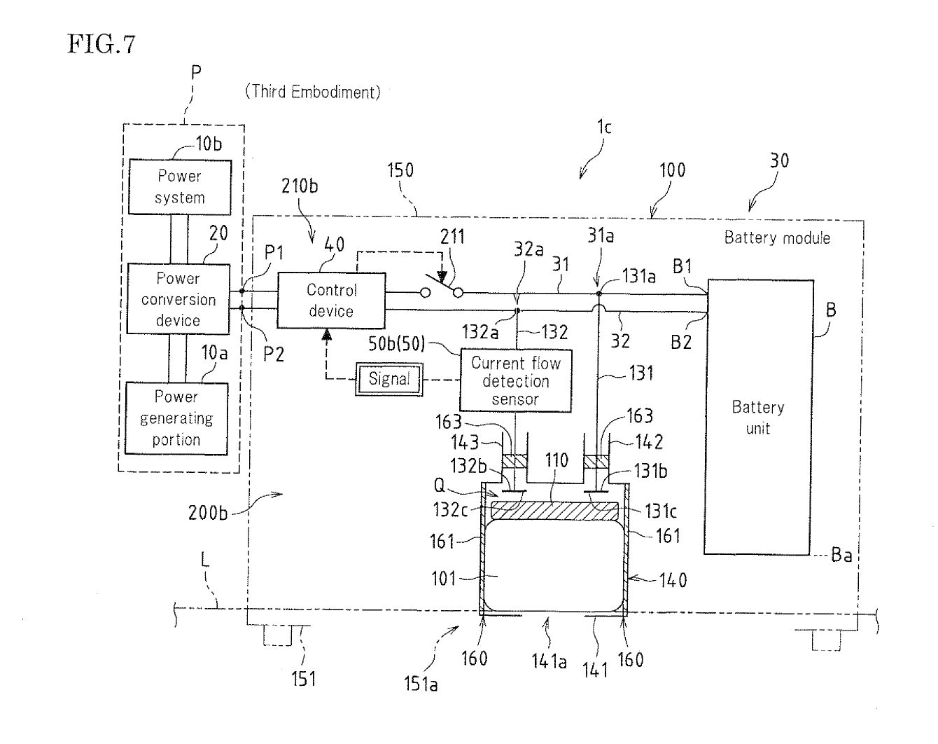

In the power generation system 1b according to the second embodiment shown in FIG. 5, the same constituent elements as in the power generation system 1a according to the first embodiment shown in FIG. 1 are given the same reference numerals, and the description thereof is omitted. The same also applies to the third to seventh embodiments shown in FIGS. 7 to 11 that will be described later.

The safety switch device 200a is provided with an interrupting device 210a capable of interrupting the connection between the external power source P and conduction portions (points where the paths branch to the discharge paths 131 and 132) 31a and 32a on the power transport paths 31 and 32 brought into conduction by the forced discharge mechanism 100.

The interrupting device 210a interrupts the connection between the external power source P and the conduction portions 31a and 32a on the power transport paths 31 and 32 following ingress of the water L.

Specifically, the interrupting device 210a can switch between a connecting state in which the connection is established between the external power source P and the conduction portions 31a and 32a on the power transport paths 31 and 32, and an interrupting state in which the connection between the external power source P and the conduction portions 31a and 32a on the power transport paths 31 and 32 is interrupted.

Specifically, the interrupting device 210a is provided with a control switch 211 for selectively switching between an ON state and an OFF state based on an electric signal, and the control device 40 for controlling the switching operation of the control switch 211. Note that here, the control device 40 in the power generation system 1b also serves as a control device that constitutes the safety switch device 200a.

The control switch 211 is connected in series between the external power source P and the conduction portion 31a/32a on the power transport path 31/32 (to the power transport path 31 between the conduction portion 31a and the control device 40, here). Note that the control switch 211 may be connected in series to the power transport path 32 or both the power transport paths 31 and 32.

The control device 40 is configured so as to switch the control switch 211 to the OFF state if it is determined that the water L has entered based on the detection result obtained by a detecting sensor 50 for detecting ingress of the water L.

The detecting sensor 50 may be provided inside the safety switch device 200a or outside the safety switch device 200a. Here, the detecting sensor 50 is provided inside and the lower end portion of the case 150. The detecting sensor 50 is connected to the input system of the control device 40. The interrupting device 210a may be provided with the detecting sensor 50.

Although the detection sensor 50 may be any sensor capable of detecting ingress of liquid such as the water L, examples of the detection sensor 50 include a liquid detection sensor for detecting the presence of liquid that has entered, based on the viewpoint of directly detecting liquid that has entered. In this case, it is possible to interrupt the connection between the external power source P and the conduction portions 31a and 32a on the power transport paths 31 and 32 upon detecting ingress of liquid with such a liquid detection sensor.

Here, the detection sensor 50 is the water detection sensor 50a for detecting the presence of the water L that has entered. Typical examples of the water detection sensor 50a include a wetness sensor for electrically detecting water that has entered inside the sensor, and a float-type water level sensor for detecting the water level by the operation of a float switch that rises up in the float. Among these, the wetness sensor operates as follows, for example.

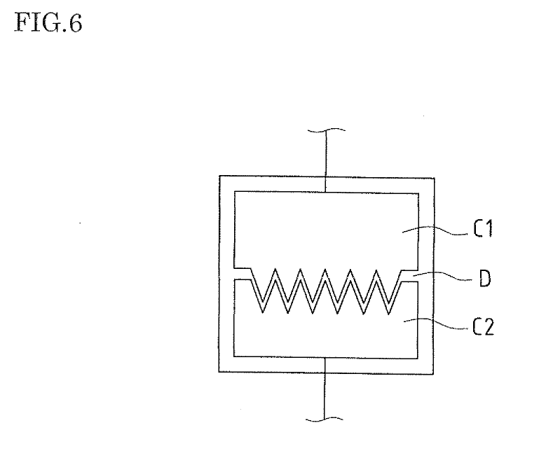

FIG. 6 is a schematic diagram illustrating water detection operation of a wetness sensor. As shown in FIG. 6, the wetness sensor has a gap D between an electrical conductive layer C1 and an electrical conductive layer C2, and if water enters into this gap D, the electrical conductive layer C1 and the electrical conductive layer C2 enters the electrically connected state. Accordingly, getting wet can be detected.

With the safety switch device 200a according to the second embodiment, in the interrupting device 210a, ingress of the water L is detected by the water detection sensor 50a provided in the case 150, a signal is transmitted to the control device 40, and the control device 40 switches the control switch 211 to the OFF state.

Further, in the forced discharge mechanism 100, the float portion 101 rises up, the electric resistor 110 provided on the upper portion of the float portion 101 comes in contact with the pair of terminals 131b and 132b (specifically, the contact portions 131c and 132c) of the discharge paths 131 and 132 so as to be electrically connected thereto, thereby causing a current to flow into the electric resistor 110.

Here, if the water detection sensor 50a is disposed such that ingress of the water L is detected by the water detection sensor 50a before the electric resistor 110 brings the pair of terminals 131b and 132b (specifically, the pair of terminals 131b and 132b via the contact portions 131c and 132c) at the other end of the discharge paths 131 and 132 into conduction, a connected state between the external power source P and the conduction portions 31a and 32a on the power transport paths 31 and 32 can be made an interrupted state prior to the electric resistor 110 bringing the discharge paths 131 and 132 into conduction.

The detection sensor 50 may be a current flow detection sensor for detecting a current flowing through the discharge paths 131 and 132.

### Third Embodiment

FIG. 7 is a diagram showing an example in which a safety switch device 200b according to a third embodiment of the present invention is applied to a power generation system 1c.

The power generation system 1c shown in FIG. 7 is obtained by providing the power generation system 1b shown in FIG. 5 with an interrupting device 210b, instead of the interrupting device 210a. Further, the interrupting device 210b is obtained by providing the interrupting device 210a with a current flow detection sensor 50b, instead of the water detection sensor 50a.

The current flow detection sensor 50b is connected in series to at least one of the discharge paths 131 and 132 (here, the discharge path 132), and is connected to the input system of the control device 40. Here, the current flow detection sensor 50b is a current detector.

With the safety switch device 200b according to the third embodiment, in the forced discharge mechanism 100, the float portion 101 rises up, the electric resistor 110 provided on the upper portion of the float portion 101 comes in contact with the pair of terminals 131b and 132b (specifically, the contact portions 131c and 132c) of the discharge paths 131 and 132 so as to be electrically connected thereto, thereby causing a current to flow into the electric resistor 110.

Then, in the interrupting device 210b, a current flowing through the discharge paths 131 and 132 is detected by the current flow detection sensor 50b, a signal is transmitted to the control device 40, and the control device 40 switches the control switch 211 to the OFF state, as with the case of the second embodiment. In this case, the control device 40 can interrupt the connection between the external power source P and the conduction portions 31a and 32a on the power transport paths 31 and 32 after recognizing that conduction is established between the power transport paths 31 and 32.

### Second and Third Embodiments

According to the second and third embodiments, the connection between the external power source P and the conduction portions 31a and 32a on the power transport paths 31 and 32 can be automatically interrupted by the interrupting devices 210a and 210b following ingress of the water L. Accordingly, it is possible to avoid conduction between the electrode terminals P1 and P2 of the external power source P being established following establishment of conduction between the power transport paths 31 and 32 by the forced discharge mechanism 100.

Further, since the interrupting devices 210a and 210b can switch between the connected and interrupted states between the external power source P and the conduction portions 31a and 32a on the power transport paths 31 and 32, the interrupting devices 210a and 210b can switch the connected state to the interrupted state when the water L enters, and can switch the interrupted state to the connected state when ingress of the water L is eliminated so that conduction between the power transport paths 31 and 32 established by the forced discharge mechanism 100 is canceled, which enables return from the interrupted state to the connected state.

Further, since the control device 40 switches the control switch 211 to the OFF state if it is determined that the water L has entered based on the detection result obtained by the detection sensor 50 (the water detection sensor 50a, the current flow detection sensor 50b) for detecting ingress of the water L, the control device 40 can reliably switch between the interrupted state and the connected state.

Further, since the control device 40 is provided on the power transport paths 31 and 32 between the external power source P and the conduction portions 31a and 32a, the electric power from the external power source P can be reliably supplied to the control device 40.

Note that in the second embodiment, for example, if a conduction time from when the water detection sensor 50a detects ingress of the water L until when the electric resistor 110 brings the pair of terminals 131b and 132b (specifically, the pair of terminals 131b and 132b via the contact portions 131c and 132c) at the other end of the discharge paths 131 and 132 into conduction is assumed in advance, and set that time in the control device 40, or if such a conduction time is calculated by detecting a temporal change in the water level of the infiltrating water L using a water-level detection sensor or the like, it is possible to adjust the time to interrupt the connection between the external power source P and the conduction portions 31a and 32a before/after conduction is established between the electric resistor 110 and the discharge paths 131 and 132.

Further, in the third embodiment, since the control device 40 interrupts the connection between the external power source P and the conduction portions 31a and 32a after recognizing that conduction between the power transport paths 31 and 32 is established, it is possible to adjust the time to interrupt the connection between the external power source P and the conduction portions 31a and 32a after conduction between the electric resistor 110 and the discharge paths 131 and 132 is established.

Further, in the second and third embodiments, based on the detection results from the water detection sensor 50a and the current flow detection sensor 50b, it is possible to adjust the time to establish connection between the external power source P and the conduction portions 31a and 32a from when it is determined that there is no ingress of the water L. In this case, in the third embodiment, since the current flow detection sensor 50b is used, the connection between the external power source P and the conduction portions 31a and 32a can be established immediately after interrupting the connection between the electric resistor 110 and the discharge paths 131 and 132.

A combination of the water detection sensor 50a in the second embodiment and the current flow detection sensor 50b in the third embodiment may be used. In this way, the advantages of both the second and third embodiments can be achieved. Specifically, it is possible to adjust the time to interrupt the connection between the external power source P and the conduction portions 31a and 32a on the power transport paths 31 and 32 before/after conduction is established between the electric resistor 110 and the discharge paths 131 and 132, and moreover the connection between the external power source P and the conduction portions 31a and 32a can be established immediately after interrupting the connection between the electric resistor 110 and the discharge paths 131 and 132.

### Fourth Embodiment

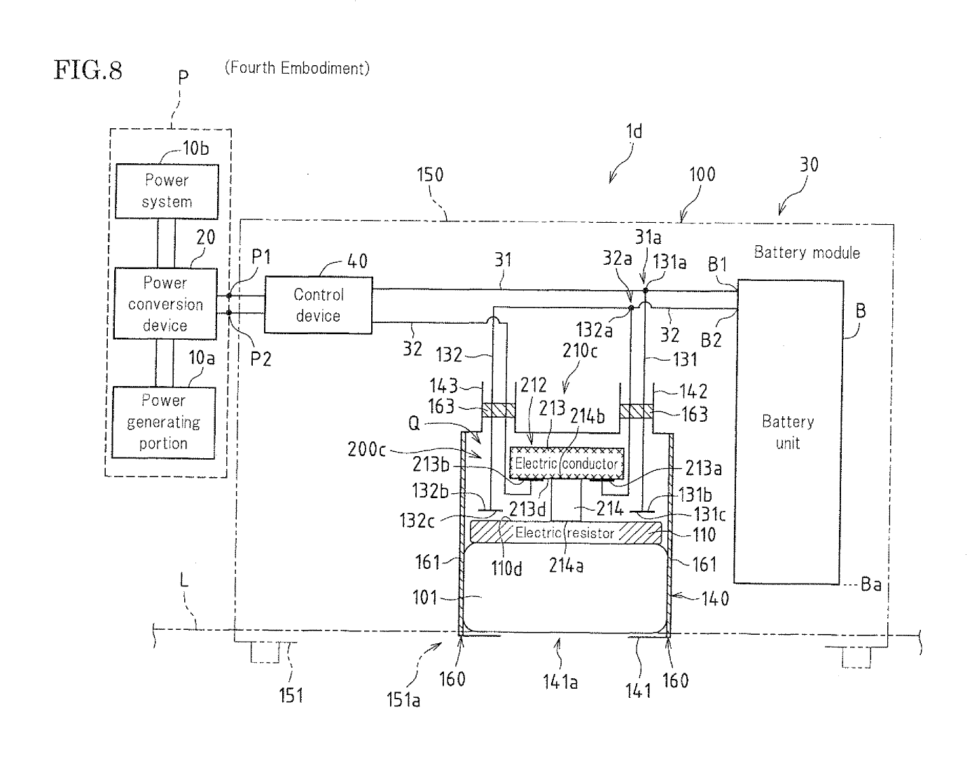

FIG. 8 is a diagram showing an example in which a safety switch device 200c according to a fourth embodiment of the present invention is applied to a power generation system 1d.

The power generation system 1d shown in FIG. 8 is obtained by providing the power generation system 1a shown in FIG. 1 with the safety switch device 200c.

The safety switch device 200c is provided with an interrupting device 210c capable of interrupting the connection between the external power source P and the conduction portions 31a and 32a on the power transport paths 31 and 32 brought into conduction by the forced discharge mechanism 100.

The interrupting device 210c interrupts the connection between the external power source P and the conduction portions 31a and 32a following ingress of the water L.

This interrupting device 210c can switch between the connected state in which the connection between the external power source P and the conduction portions 31a and 32a on the power transport paths 31 and 32 is established and the interrupted state in which the connection between the external power source P and the conduction portions 31a and 32a on the power transport paths 31 and 32 is interrupted.

Specifically, the interrupting device 210c is provided with a gravity switch 212 having a switch portion 213 that maintains the ON state due to gravity and enters the OFF state by being pushed up against gravity, and an actuator portion 214 for pushing up the switch portion 213.

The switch portion 213 is connected in series between the external power source P and the conduction portion 31a/32a on the power transport path 31/32 (here, to the power transport path 32 between the conduction portion 32a and the control device 40). Note that the switch portion 213 may be connected in series to the power transport path 31 or both the power transport paths 31 and 32.

The gravity switch 212 has a pair of switch terminals 213a and 213b in addition to the switch portion 213. The gravity switch 212 is disposed inside and the upper portion of the guide portion 140.

The switch terminals 213a and 213b are connected in series to the power transport path 32 pulled in the guide portion 140 from the introducing portions 142 and 143 of the forced discharge mechanism 100 between the conduction portion 32a and the control device 40.

Here, the switch portion 213 is a rod-shaped electric conductor. The switch portion 213 is placed on the switch terminals 213a and 213b extending across the switch terminals 213a and 213b and maintaining the current flow state due to gravity. Note that from the viewpoint of reliably causing the switch portion 213 to come in contact with the switch terminals 213a and 213b, the interrupting device 210c may be provided with a biasing member (not shown) such as a spring for biasing the switch portion 213 toward the switch terminals 213a and 213b.

The actuator portion 214 is configured to operate in coordination with the float portion 101 when the float portion 101 rises up due to the buoyant force following ingress of the water L.

Specifically, the actuator portion 214 is a pillar-shaped element, and is disposed between the switch portion 213 and the float portion 101 and/or the electric resistor 110.

Further, the pair of terminals 131b and 132b at the other end of the discharge paths 131 and 132 stop the electric resistor 110 further rising up by the electric resistor 110 that rises up coming in contact with the pair of terminals 131b and 132b (specifically, the contact portions 131c and 132c).

In the fourth embodiment, the actuator portion 214 is coupled to both the switch portion 213 and the float portion 101 and/or the electric resistor 110.

Specifically, the actuator portion 214 has a bottom portion 214a connected to a top portion 110d of the electric resistor 110 and a top portion 214b connected to a bottom portion 213d of the switch portion 213.

With the safety switch device 200c according to the fourth embodiment, the float portion 101 rises up together with the actuator portion 214 coupled to the float portion 101 and/or the electric resistor 110 due to the water L that has entered to the inside, and the switch portion 213 coupled to the actuator portion 214 that has risen up is pushed up from below, thereby causing the gravity switch 212 to enter the OFF state, which temporarily interrupts the power transport paths 31 and 32 between the external power source P and the conduction portions 31a and 32a. At this time, the power transport paths 31 and 32 are interrupted in an instant by the float portion 101 even slightly rising up.

On the other hand, if the water level of the water L that has entered drops, the switch portion 213 is placed on the switch terminals 213a and 213b, which causes the gravity switch 212 to enter the ON state, and thus the power transport paths 31 and 32 between the external power source P and the conduction portions 31a and 32a are reconnected.

### Fifth Embodiment

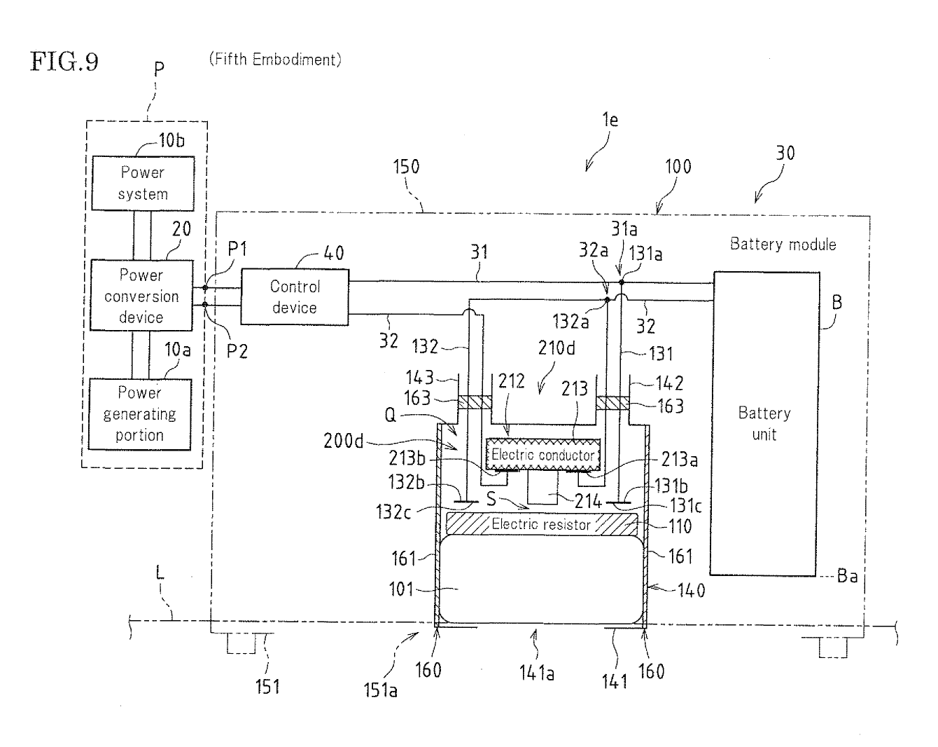

FIG. 9 is a diagram showing an example in which a safety switch device 200d according to a fifth embodiment of the present invention is applied to a power generation system 1e.

An interrupting device 210d in the power generation system 1e shown in FIG. 9 is obtained by coupling the actuator portion 214 to either the switch portion 213 or the float portion 101 and/or the electric resistor 110 (the switch portion 213 in the example shown in the figure) in the interrupting device 210c of the safety switch device 200c shown in FIG. 8.

With the safety switch device 200d according to the fifth embodiment, since the actuator portion 214 described in the fourth embodiment shown in FIG. 8 is coupled to either the switch portion 213 or the float portion 101 and/or the electric resistor 110, when there is no ingress of the water L (when the float portion 101 is at a lower position), the actuator portion 214 and the switch portion 213 are separated, or the actuator portion 214 and the float portion 101 and/or the electric resistor 110 are separated (the actuator portion 214 and the electric resistor 110 are separated in the example shown in the figure), and a gap S is provided therebetween. In this case, the movement due to the float portion 101 slightly rising up is absorbed, and even if the float portion 101 starts rising up, the power transport paths 31 and 32 between the external power source P and the conduction portions 31a and 32a are not immediately interrupted.

In this case as well, as with the case of the fourth embodiment, if the water level of the water L that has entered drops, the switch portion 213 is placed on the switch terminals 213a and 213b, causing the gravity switch 212 to enter the ON state, and thereby the power transport paths 31 and 32 between the conduction portions 31a and 32a and the external power source P are reconnected.

Note that in the fifth embodiment, the actuator portion 214 may not be coupled to either the switch portion 213 or the float portion 101 and the electric resistor 110. In this case, it is possible to provide a support member (not shown) for supporting the actuator portion 214 to be movable in the vertical direction.

### Fourth and Fifth Embodiments

In the fourth and fifth embodiments, since the pair of terminals 131b and 132b prevent the electric resistor 110 from rising up by the electric resistor 110 coming in contact with the pair of terminals 131b and 132b (specifically, the contact portions 131c and 132c) at the other end of the discharge paths 131 and 132, the connection between the external power source P and the conduction portions 31a and 32a on the power transport paths 31 and 32 is interrupted by the actuator portion 214 pushing up the switch portion 213, and thereafter the electric resistor 110 comes in contact with the pair of terminals 131b and 132b (specifically, the contact portions 131c and 132c) at the other end of the discharge paths 131 and 132, thereby establishing conduction between the power transport paths 31 and 32.

Note that a configuration may be adopted in which the electric resistor 110 is allowed to rise up while the electric resistor 110 is in contact with the pair of terminals 131b and 132b (specifically, the contact portions 131c and 132c) (the electric resistor 110 slides while the pair of terminals 131b and 132b (specifically, the contact portions 131c and 132c) and the electric resistor 110 are in contact with each other). In this case, the electric resistor 110 comes in contact with the pair of terminals 131b and 132b (specifically, the contact portions 131c and 132c), thereby establishing conduction between the power transport paths 31 and 32, and thereafter the connection between the external power source P and the conduction portions 31a and 32a on the power transport paths 31 and 32 can be interrupted by the actuator portion 214 pushing up the switch portion 213.

According to the fourth and fifth embodiments, the interrupting devices 210c and 210d can avoid conduction between the electrode terminals P1 and P2 of the external power source P being established following establishment of conduction between the power transport paths 31 and 32 by the forced discharge mechanism 100. Further, the interrupting devices 210c and 210d can return the state between the external power source P and the conduction portions 31a and 32a on the power transport paths 31 and 32 from the interrupted state to the connected state. Moreover, the connection between the external power source P and the conduction portions 31a and 32a on the power transport paths 31 and 32 can be interrupted utilizing the forced discharge mechanism 100.

Further, in the fourth embodiment, since the actuator portion 214 is coupled to both the switch portion 213 and the float portion 101 and/or the electric resistor 110, the float portion 101 and the switch portion 213 can be reliably caused to operate in coordination with each other via the actuator portion 214. Further, in the fifth embodiment, since the actuator portion 214 is coupled to either the switch portion 213 or the float portion 101 and/or the electric resistor 110, it is possible to suppress the influence from the float portion 101 shaking due to waves generated at the surface of the water L being exerted on the connected state between the external power source P and the conduction portions 31a and 32a.

### Sixth Embodiment

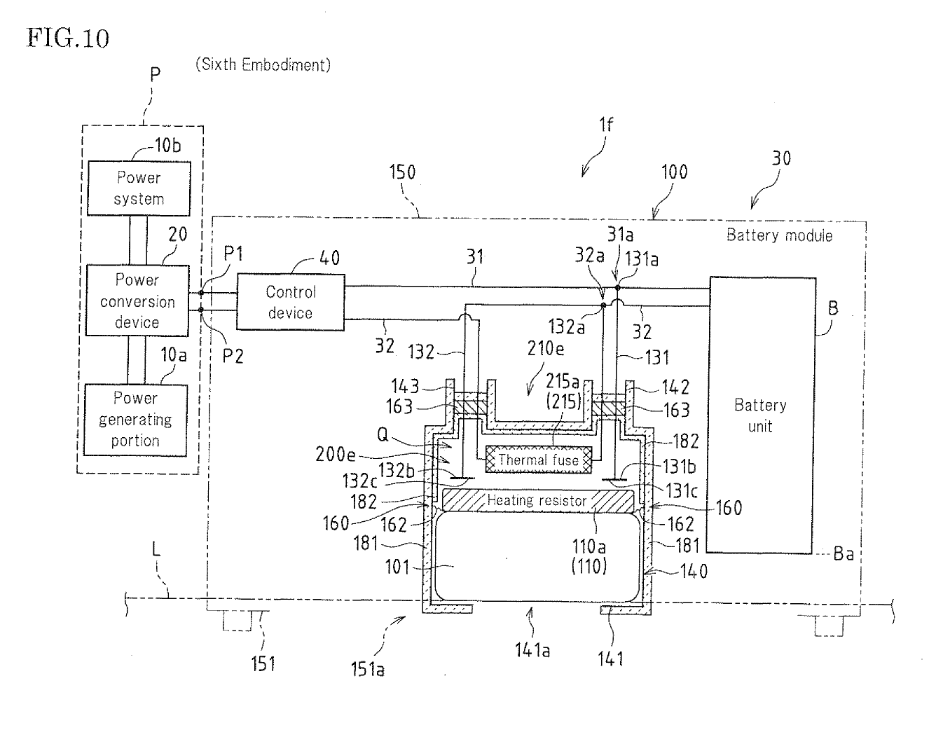

FIG. 10 is a diagram showing an example in which a safety switch device 200e according to a sixth embodiment of the present invention is applied to a power generation system if.

The power generation system If shown in FIG. 10 is obtained by providing the power generation system 1a shown in FIG. 1 with the safety switch device 200e.

The safety switch device 200e is provided with an interrupting device 210e capable of interrupting the connection between the external power source P and the conduction portions 31a and 32a on the power transport paths 31 and 32 brought into conduction by the forced discharge mechanism 100.

The interrupting device 210e interrupts the connection between the external power source P and the conduction portions 31a and 32a following ingress of the water L.

Specifically, the interrupting device 210e has a conductive connecting body 215 that is connected in series between the external power source P and the conduction portions 31a and 32a on the power transport paths 31 and 31, and is configured such that the connecting body 215 is split between the external power source P and the storage battery B following ingress of the water L.

Specifically, the electric resistor 110 is a heating resistor 110a, and the connecting body 215 is a thermal fuse 215a that is blown due to heat generated by the heating resistor 110a.

The thermal fuse 215a is connected in series between the external power source P and the conduction portion 31a/32a on the power transport path 31/32 (here, to the power transport path 32 between the conduction portion 32a and the control device 40). Note that the thermal fuse 215a may be connected in series to the power transport path 31, or both the power transport paths 31 and 32.

Further, the thermal fuse 215a is connected in series to the power transport path 32 pulled in the guide portion 140 from the introducing portions 142 and 143 of the forced discharge mechanism 100 between the conduction portion 32a and the control device 40. The thermal fuse 215a is disposed in the vicinity of the heating resistor 110a such that it can blow at a rated temperature.

With the safety switch device 200e according to the sixth embodiment, in the forced discharge mechanism 100, the float portion 101 rises up due to the buoyant force of the water L that has entered, the storage battery B is forcibly discharged, and the heating resistor 110a generates heat, and when the ambient temperature becomes sufficiently high, the thermal fuse 215a blows, thereby interrupting the connection between the external power source P and the conduction portions 31a and 32a on the power transport paths 31 and 32. Here, if electric power is supplied from the external power source P to the storage battery B via the power conversion device 20, the amount of current that flows through the heating resistor 110a becomes larger, which makes the amount of generated heat increasingly larger. Accordingly, the time required to blow the thermal fuse 215a can be shortened, and thus the connection between the external power source P and the conduction portions 31a and 32a on the power transport paths 31 and 32 can be interrupted earlier. In this sixth embodiment, conduction between the power transport paths 31 and 32 is established, and thereafter the connection between the external power source P and the conduction portions 31a and 32a is interrupted.

If the water L comes in contact with the contact portions 131c and 132c of the discharge paths 131 and 132 that come in contact with the heating resistor 110a, in the case where, for example, the water L that has entered is evaporated by heat generated by the heating resistor 110a other than the occurrence of the electrolysis mentioned above, there is a possibility that the thermal fuse 215a may not blow because thermal energy is used by evaporation. Moreover, the internal pressure of the space Q in which the contact portions 131c and 132c exist is increased by evaporation, and the rising-up operation of the float portion 101 is suppressed, which makes it difficult to perform a forced discharge operation, and besides there is a possibility that discharge may be discontinued even if a forced discharge operation is performed. Further, heat generation of the heating resistor 110a is suppressed due to electrolysis and evaporation, which also hampers the blowing operation of the thermal fuse 215a.

In view of this, it is preferable to apply a liquid-tight configuration as shown in FIGS. 1 to 4 to the safety switch device 200e shown in FIG. 10. Note that in the example in FIG. 10, the first flexible film 162 in FIG. 2 is provided, instead of the insulating seal material 161 in FIG. 1.

In this way, it is possible to prevent the water L from coming in contact with the contact portions 131c and 132c of the discharge paths 131 and 132 that come in contact with the heating resistor 110a.

Further, in the sixth embodiment, better responsiveness of the thermal fuse 215a is achieved the more different the directions of transferring heat from the heating resistor 110a are. For this reason, in order to suppress transfer of heat generated by the heating resistor 110a to the float portion 101 and the case 150 as much as possible, the outside of the guide portion 140 is given a heat insulating structure (a structure for covering with a heat insulating material) 181, or/and furthermore (here, and furthermore) the inside of the guide portion 140 (in particular, the space Q) including the float is given a heat insulating structure (a structure for covering with a heat insulating material) 182.

Although any material that can insulate heat generated by the heating resistor 110a may be used as the material for the above heat insulating structures 181 and 182, a heat insulating material such as a vacuum heat insulation panel can be used, not to mention a typical heat insulating material such as styrene foam or foaming polyurethane.

According to the sixth embodiment, the interrupting device 210e can avoid conduction between the electrode terminals P1 and P2 of the external power source P being established following establishment of conduction between the power transport paths 31 and 32 by the forced discharge mechanism 100.

Further, in the sixth embodiment, with the heating resistor 110a serving as the electric resistor 110, the thermal fuse 215a can interrupt the connection between the external power source P and the conduction portions 31a and 32a on the power transport paths 31 and 32 utilizing heat generated by the heating resistor 110a.

Further, since the heat insulating structure for insulating heat generated by the heating resistor 110a is provided, the temperature rise efficiency of the thermal fuse 215a can be improved, and thus the connection between the external power source P and the conduction portions 31a and 32a can be interrupted earlier.

### Seventh Embodiment

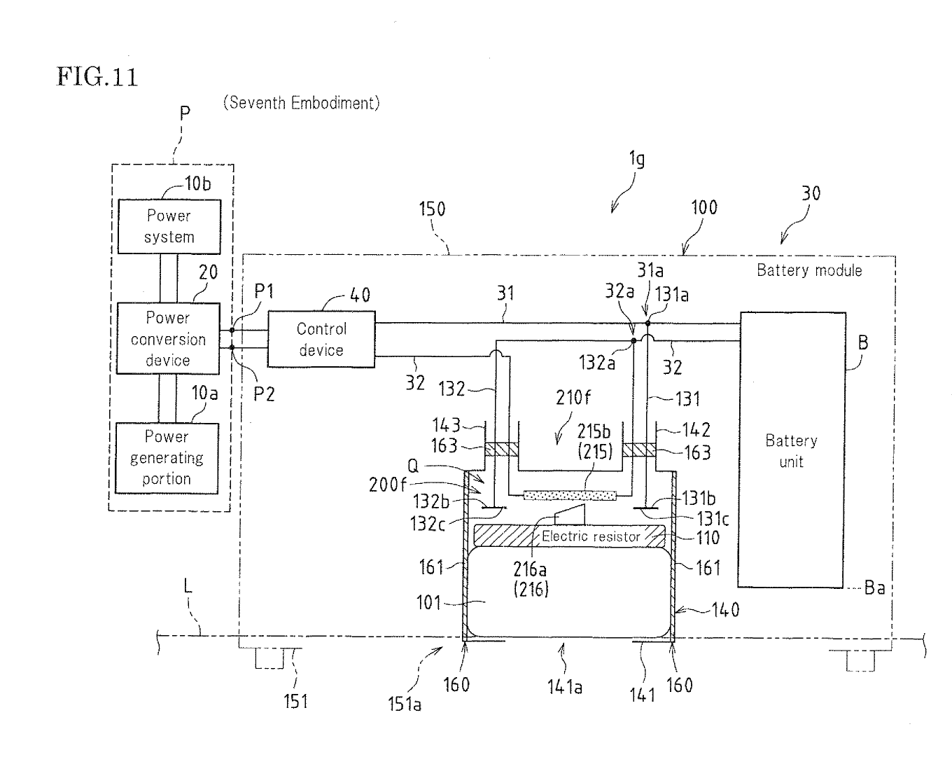

FIG. 11 is a diagram showing an example in which a safety switch device 200f according to a seventh embodiment of the present invention is applied to a power generation system 1g.

The power generation system 1g shown in FIG. 11 is obtained by providing the power generation system 1a shown in FIG. 1 with the safety switch device 200f.

The safety switch device 200f is provided with an interrupting device 210f capable of interrupting the connection between the external power source P and the conduction portions 31a and 32a on the power transport paths 31 and 32 brought into conduction by the forced discharge mechanism 100.

The interrupting device 210f interrupts the connection between the external power source P and the conduction portions 31a and 32a following ingress of the water L.

Specifically, the interrupting device 210f has the conductive connecting body 215 that is connected in series between the external power source P and the conduction portion 31a/32a on the power transport path 31/31, and is configured such that the connecting body 215 is split between the external power source P and the storage battery B following ingress of the water L.

Specifically, the interrupting device 210f is provided with a splitting member 216 for splitting the connecting body 215. The connecting body 215 is an split electric conductor 215b to be split, which can be split by the splitting member 216. The splitting member 216 is configured to split the split electric conductor 215b when the float portion 101 rises up due to the buoyant force following ingress of the water L.

The split electric conductor 215b is connected in series between the external power source P and the conduction portion 31a/32a on the power transport path 31/32 (here, to the power transport path 32 between the conduction portion 32a and the control device 40). Note that the split electric conductor 215b may be connected in series to the power transport path 31 or both the power transport paths 31 and 32.

Further, the split electric conductor 215b is connected in series to the power transport path 32 pulled in the guide portion 140 from the introducing portions 142 and 143 of the forced discharge mechanism 100 between the conduction portion 32a and the control device 40. The split electric conductor 215b is disposed inside and the upper portion of the guide portion 140.

The splitting member 216 is provided on the float portion 101 and/or the electric resistor 110 so as to protrude from the top face of the electric resistor 110.

Further, the pair of terminals 131b and 132b at the other end of the discharge paths 131 and 132 stop the electric resistor 110 further rising up by the electric resistor 110 that rises up coming in contact with the pair of terminals 131b and 132b (specifically, the contact portions 131c and 132c).

Examples of the splitting member 216 include a pressing member (e.g., a rod-shaped member) for pressing against the split electric conductor 215b, and a cutting blade for cutting and splitting the split electric conductor 215b.

As the split electric conductor 215b, an element formed with the material that can be easily split by the splitting member 216 (e.g., fractured due to being pressed or cut with the cutting blade), and/or an element formed into a shape that can be easily split by the splitting member 216 (e.g., fractured due to being pressed or cut with the cutting blade) can be given as an example.

Typical examples of a material that can be easily split by the splitting member 216 include a conductive resin. Examples of an element formed with a conductive resin include a conductive resin sheet and a flexible lead wire. Such a conductive resin sheet and a flexible lead wire can be easily cut with a cutting blade, for example.

In the case where the split electric conductor 215b is formed with, for example, a conductive resin, and the splitting member 216 is a cutting blade 216a, with the safety switch device 200f according to the seventh embodiment, the cutting blade 216a protruding from the top face of the electric resistor 110 cuts off the split electric conductor 215b formed with a conductive resin in accordance with the movement of the float portion 101, thereby interrupting the connection between the external power source P and the conduction portions 31a and 32a on the power transport paths 31 and 32.

Further, typical examples of a material suitable for processing into the shape that can be easily split by the splitting member 216 include a carbon material. Further, examples of the shape that can be easily split by the splitting member 216 include a depressed groove shape extending in one direction (specifically, V shape laterally viewed).

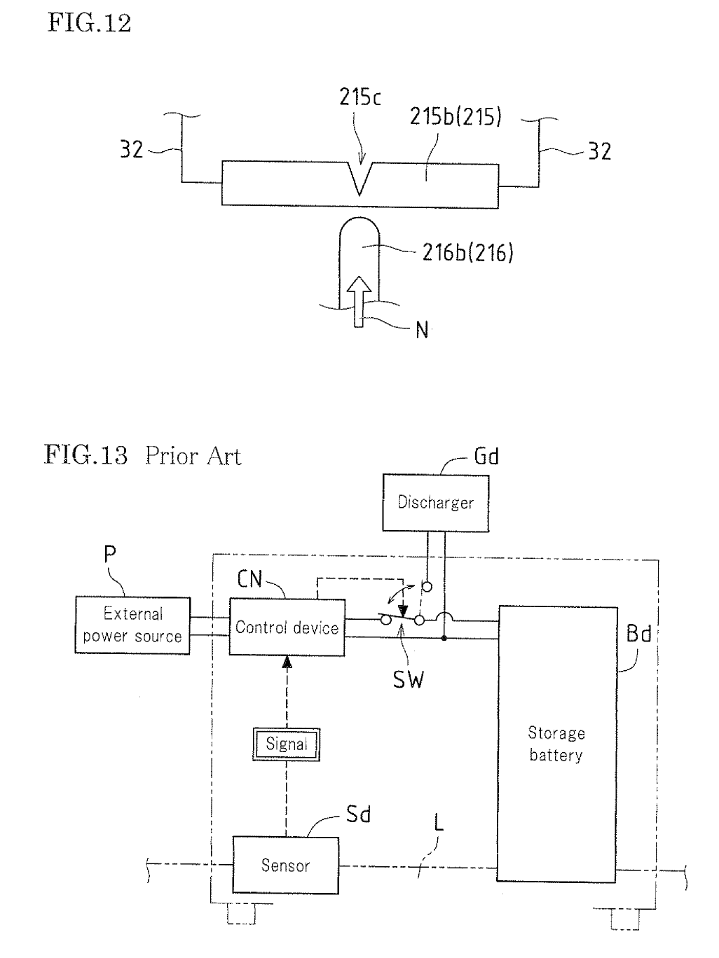

FIG. 12 is a schematic diagram of the split electric conductor 215b that has a groove portion 215c that is laterally viewed. As shown in FIG. 12, the groove portion 215c that has a V shape laterally viewed and extends in one direction is formed in the split electric conductor 215b.

In the case where, for example, the V-shaped groove portion 215c shown in FIG. 12 is formed in the split electric conductor 215b, and the splitting member 216 is a pressing member 216b, with the safety switch device 200f according to the seventh embodiment, if a pushing-up load N is applied by the pressing member 216b from below due to the float portion 101 that has risen up due to the buoyant force following ingress of the water L, the conductivity of the split electric conductor 215b is eliminated by being broken at the groove portion 215c.

In the seventh embodiment, the pair of terminals 131b and 132b at the other end of the discharge paths 131 and 132 stop the electric resistor 110 rising up by the electric resistor 110 that rises up coming in contact with the pair of terminals 131b and 132b (specifically, the contact portions 131c and 132c), and thus the split electric conductor 215b is split by the splitting member 216, which interrupts the connection between the external power source P and the conduction portions 31a and 32a on the power transport paths 31 and 32, and thereafter the electric resistor 110 comes in contact with the pair of terminals 131b and 132b (specifically, the contact portions 131c and 132c) at the other end of the discharge paths 131 and 132, thereby establishing conduction between the power transport paths 31 and 32.

Note that a configuration may be adopted in which the electric resistor 110 is allowed to rise up while the electric resistor 110 is in contact with the pair of terminals 131b and 132b (specifically, the contact portions 131c and 132c) (the electric resistor 110 slides while the pair of terminals 131b and 132b and the electric resistor 110 are in contact with each other). In this case, the electric resistor 110 comes in contact with the pair of terminals 131b and 132b (specifically, the contact portions 131c and 132c), thereby establishing conduction between the power transport paths 31 and 32, and thereafter the connection between the external power source P and the conduction portions 31a and 32a on the power transport paths 31 and 32 can be interrupted by the splitting member 216 splitting the split electric conductor 215b.

According to the seventh embodiment, the interrupting device 210f can avoid conduction between the electrode terminals P1 and P2 of the external power source P being established following establishment of conduction between the power transport paths 31 and 32 by the forced discharge mechanism 100. Moreover, the connection between the external power source P and the conduction portions 31a and 32a on the power transport paths 31 and 32 can be interrupted utilizing the forced discharge mechanism 100.

### First to Seventh Embodiments

As described above, with the forced discharge mechanism 100 according to the first embodiment and the safety switch devices 200a to 200f according to the second to seventh embodiments, it is possible to prevent a problem such as generation of heat by the occurrence of an electric leakage or a short circuit due to getting wet between the positive electrode terminal B1 and the negative electrode terminal B2 of the storage battery B, in a region where a flood frequently occurs or the like, for example. Furthermore, with the safety switch devices 200a to 200f according to the second to seventh embodiments, it is possible to avoid an electric leakage from the external power source P to the electric resistor 110 being caused by conduction between the electrode terminals P1 and P2 of the external power source P being established following establishment of conduction between the power transport paths 31 and 32 by the forced discharge mechanism 100.

Further, if at least one of the safety switch devices 200a to 200d and 200f according to the second to fifth and seventh embodiments is used, it is possible to select whether to set the time to interrupt the connection between the power transport paths 31 and 32 before the start of forced discharge or thereafter. Further, if at least one of the safety switch devices 200a to 200d according to the second to fifth embodiments is used, it is also possible to adjust the time interval between when to interrupt the connection between the power transport paths 31 and 32 and when to start discharge.

Further, with the safety switch device 200e according to the sixth embodiment, it is advantageous that when the thermal fuse 215a blows due to generated heat, an increase in the amount of generated heat by electric power from the external power source P also being temporarily supplied to the heating resistor 110a leads to earlier blowing of the thermal fuse 215a.

Note that the forced discharge mechanism 100 according to the first embodiment and the safety switch devices 200a to 200f according to the second to seventh embodiments are also effective as the mechanism for preventing a passenger from receiving the electric shock when, for example, involved in a disaster such as a road being covered with water, by being applied to a hybrid electric vehicle in which the engine used as the main power also serves as the power generator, an electric vehicle, and furthermore a fuel cell electric vehicle.

Further, the forced discharge mechanism 100 according to the first embodiment and the safety switch devices 200a to 200f according to the second to seventh embodiments have few portions that require mechanical operation, and do not use electrical control configurations such as an electric circuit and an integrated circuit that are difficult to operate during a power failure, for example, and thus, the reliability thereof can be increased, and the mechanism and devices can also be suitably used for products that do not operate for a long period of time, and operate only in the emergency.

What is claimed is:

1. A forced discharge mechanism for a storage battery for forcibly establishing conduction between a pair of power transport paths that are respectively connected to a positive electrode and a negative electrode of the storage battery, comprising:
an electric resistor for establishing conduction between the power transport paths,
wherein the electric resistor is movable due to a buoyant force of liquid that has entered.

2. The forced discharge mechanism for a storage battery according to claim 1,
wherein the mechanism is provided in a product for use outdoors.

3. The forced discharge mechanism for a storage battery according to claim 1, comprising:
a float portion that has a lower relative specific gravity than a specific gravity of liquid;
discharge paths each having a terminal at one end that is connected to a different one of the power transport paths, and a terminal at the other end that is connectable to the electric resistor; and
a guide portion for guiding the float portion which the electric resistor is provided.

4. The forced discharge mechanism for a storage battery according to claim 3, comprising:
a case for covering the storage battery.

5. The forced discharge mechanism for a storage battery according to claim 3,
wherein a surface of liquid when the electric resistor is caused to come into contact with the pair of terminals at the other end of the discharge paths is at a lower position than positions of electrode terminals of the storage battery.

6. The forced discharge mechanism for a storage battery according to claim 3,
wherein a liquid-tight structure is provided between the float portion and the guide portion.

7. The forced discharge mechanism for a storage battery according to claim 3,
wherein the guide portion covers, in a liquid-tight manner, at least contact portions of the pair of terminals at the other end of the discharge paths that come in contact with the electric resistor.

8. The forced discharge mechanism for a storage battery according to claim 3, comprising:
a heat dissipation structure for dissipating heat generated by the electric resistor.

9. The forced discharge mechanism for a storage battery according to claim 8,
wherein the heat dissipation structure dissipates heat generated by the electric resistor from an entire surface of the forced discharge mechanism.

10. The forced discharge mechanism for a storage battery according to claim 3,
wherein the electric resistor has a resistance value that enables discharge of the storage battery for 1000 seconds to 10 hours.

11. The forced discharge mechanism for a storage battery according to claim 3, comprising:
a capacitor that is connected to the discharge paths such that the capacitor is in parallel with the electric resistor that comes in contact with the discharge paths.

12. The forced discharge mechanism for a storage battery according to claim 11,
wherein the capacitor has a withstand voltage of 100V or more and a capacitance of 10 pF to 1000 pF.

13. A safety switch device is for interrupting power transport paths that are connected between an external power source and a storage battery, the safety switch device comprising:
a forced discharge mechanism for the storage battery according to claim 1; and
an interrupting device that is capable of interrupting a connection between the external power source and a conduction portion on each of the power transport paths brought into conduction by the forced discharge mechanism,
wherein the interrupting device interrupts the connection between the conduction portions and the external power source following ingress of liquid.

14. A safety switch device is for interrupting power transport paths that are connected between an external power source and a storage battery, the safety switch device comprising:
a forced discharge mechanism for the storage battery according to claim 3; and
an interrupting device that is capable of interrupting a connection between the external power source and a conduction portion on each of the power transport paths brought into conduction by the forced discharge mechanism,
wherein the interrupting device interrupts the connection between the external power source and the conduction portions on the power transport paths, prior to the electric resistor bringing the pair of terminals at the other end of the discharge paths into conduction following ingress of liquid.

15. The safety switch device according to claim 13,
wherein the interrupting device is capable of switching between a connected state in which the connection between the external power source and the conduction portions on the power transport paths is established, and an interrupted state in which the connection between the external power source and the conduction portions on the power transport paths is interrupted.

16. The safety switch device according to claim 15,
wherein the interrupting device includes a control switch for switching between an ON state and an OFF state based on an electrical signal, and a control device for controlling a switching operation of the control switch,
the control switch is connected in series between the external power source and at least one of the conduction portions on the power transport paths, and
the control device switches the control switch to the OFF state if it is determined that liquid has entered based on a detection result obtained by a detection sensor for detecting ingress of liquid.

17. The safety switch device according to claim 16,
wherein the control device is provided on the power transport paths between the conduction portions and the external power source.

18. A safety switch device is for interrupting power transport paths that are connected between an external power source and a storage battery, the safety switch device comprising:
a forced discharge mechanism for the storage battery according to claim 3; and
an interrupting device that is capable of interrupting a connection between the external power source and a conduction portion on each of the power transport paths brought into conduction by the forced discharge mechanism,
wherein the interrupting device includes a gravity switch having a switch portion that maintains an ON state due to gravity and enters an OFF state by being pushed up against gravity, and an actuator portion for pushing up the switch portion,
the switch portion is connected in series between the external power source and at least one of the conduction portions on the power transport paths, and
the actuator portion operates in coordination with the float portion when the float portion rises up due to the buoyant force following ingress of liquid.

19. The safety switch device according to claim 18,
wherein the actuator portion is not connected to either the switch portion or the float portion and the electric resistor, or is connected to one of the switch portion, the float portion, the electric resistor, and the float portion and the electric resistor.

20. A safety switch device is for interrupting power transport paths that are connected between an external power source and a storage battery, the safety switch device comprising:
a forced discharge mechanism for the storage battery according to claim 3; and
an interrupting device that is capable of interrupting a connection between the external power source and a conduction portion on each of the power transport paths brought into conduction by the forced discharge mechanism,
wherein the interrupting device has a conductive connecting body that is connected in series between the external power source and at least one of the conduction portions on the power transport paths, and the connecting body is split between the external power source and the storage battery following ingress of liquid.

21. A safety switch device is for interrupting power transport paths that are connected between an external power source and a storage battery, the safety switch device comprising:
a forced discharge mechanism for the storage battery according to claim 3; and
an interrupting device that is capable of interrupting a connection between the external power source and a conduction portion on each of the power transport paths brought into conduction by the forced discharge mechanism,
wherein the interrupting device has a conductive connecting body that is connected in series between the external power source and at least one of the conduction portions on the power transport paths, and the connecting body is split between the external power source and the storage battery following ingress of liquid, and
the electric resistor is a heating resistor, and the connecting body is a thermal fuse that is blown due to heat generated by the heating resistor.

22. The safety switch device according to claim 21, comprising:
a heat insulating structure for insulating heat generated by the heating resistor.

23. The safety switch device according to claim 20,
wherein the interrupting device includes a splitting member for splitting the connecting body, the connecting body is a split electric conductor to be split that is splittable by the splitting member, and the splitting member splits the split electric conductor to be split when the float portion rises up due to the buoyant force following ingress of liquid.

24. The safety switch device according to claim 13,
wherein the external power source is a solar cell in a solar power generation system that is interconnected with a power system or a fuel cell in a fuel cell system that is interconnected with a power system.

25. The safety switch device according to claim 13,
wherein the storage battery is a power source for an electric vehicle or a hybrid electric vehicle.
